(19) United States
(12) Patent Application Publication
(10) Pub. No.: US 2025/0348749 A1
(43) Pub. Date: Nov. 13, 2025

(54) LEARNING TASKS USING SKILL SEQUENCING FOR TEMPORALLY-EXTENDED EXPLORATION

(71) Applicant: DeepMind Technologies Limited, London (GB)

(72) Inventors: Giulia Vezzani, London (GB); Dhruva Tirumala Bukkapatnam, London (GB); Markus Wulfmeier, London (GB); Martin Riedmiller, Balgheim (DE); Nicolas Manfred Otto Heess, London (GB)

(21) Appl. No.: 18/867,874

(22) PCT Filed: Sep. 27, 2023
(86) PCT No.: PCT/EP2023/076798

§ 371 Date: Nov. 21, 2024

Related U.S. Application Data
(60) Provisional application No. 63/410,927, filed on Sep. 28, 2022.

(51) Int. Cl. G06N 3/092

(52) U.S. Cl. CPC G06N 3/092

(57) ABSTRACT

Methods, systems, and apparatus, including computer programs encoded on a computer storage medium, for controlling an agent that is interacting with an environment. Implementations of the system use previously learned skills to explore states of the environment to collect and store training data, which is then used to train an action selection system. The system includes a set of skill action selection subsystems, each configured to select actions for the agent to perform for a respective skill. The set of skill action selection subsystems is used to explore states of the environment to collect the training data, keeping their individual action selection policies unchanged. A scheduler neural network selects the skill neural networks to use. The action selection system is trained on the stored training data.

### CROSS-REFERENCE TO RELATED APPLICATION

This application claims priority to U.S. Provisional Application No. 63/410,927, filed on Sep. 28, 2022. The disclosure of the prior application is considered part of and is incorporated by reference in the disclosure of this application.

### BACKGROUND

This specification relates to machine learning, in particular reinforcement learning.

Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current values of a respective set of parameters.

In a reinforcement learning system an agent interacts with an environment, e.g., a real-world environment, by performing actions that are selected by the reinforcement learning system in response to receiving successive “observations”, i.e. datasets that characterize the state of at least part of the environment at corresponding time-steps, e.g., the outputs of sensor(s) which sense at least part of the real world environment at those time-steps.

### SUMMARY

This specification describes a system, implemented as computer programs on one or more computers in one or more locations, for controlling an agent that is interacting with an environment. More particularly implementations of the system use previously learned skills to explore states of the environment to collect training data, which is then used to train an action selection system, e.g. comprising an action selection neural network.

In one aspect there is described a method, and a corresponding system, implemented by one or more computers, for training an action selection system, e.g. an action selection neural network, to generate action control data for controlling an agent to perform a learned task in an environment.

The system includes a set of skill action selection subsystems, each configured to select actions for the agent to perform for a respective skill task, i.e. a task that the respective skill action selection subsystem has been trained to perform. The skill action selection subsystems are used to explore states of the environment to collect training data, keeping their individual action selection policies unchanged whilst collecting the training data. More particularly, at each of a plurality of scheduler action time steps a scheduler neural network generates a scheduler action that selects one of the skill neural networks, which is then used select actions for the agent, until one of the skill neural networks is again selected at the next scheduler action time step. The collected training data is stored and the action selection system is trained on the stored training data.

The subject matter described in this specification can be implemented in particular embodiments so as to realize one or more of the following advantages.

In principle being able to re-use previously learned skills is useful as training can be time-consuming and, in a real-world environment, can result in wear and tear on the agent. However some existing approaches have drawbacks. For example, approaches based on fine-tuning previously learned models can suffer from loss if useful information or “catastrophic forgetting”, particularly in sparse reward tasks. Approaches based on imitating previously learned “expert” skills can suffer when the “experts” are sub-optimal, stalling at the level of the transferred skill. Implementations of the described methods and systems use a different paradigm, in which previously learned skills are used to explore an environment to collect training for training an action selection system, in particular an action selection neural network.

Some implementations of the described techniques can re-use previously learned skills, but in a way that does not constrain the learned solution, and without catastrophic forgetting. The described techniques also facilitate exploration over increased time scales, which is generally beneficial. Implementations of the system allow previously learned skills to be flexibly combined and adapted to learn new tasks. Some implementations of the system are particularly useful for complex manipulation and locomotion tasks. Some implementations of the system are particularly useful when rewards are sparse. This facilitates use of the techniques in many applications including, e.g., robotics where designing dense rewards can be time-consuming and can be prone to result in unexpected behavior.

By contrast to some reinforcement techniques that use temporarily extended skills or “options”, implementations of the described system freeze existing skills and use them for exploring the environment to collect training data that is then used to train the action selection system. Once the action selection system has been trained the scheduler neural network no longer needs to be used. In some implementations the action selection system is one of the set of skills that the scheduler can use. However in such implementations, even though the scheduler neural network can select the action selection system, counterintuitively the performance of the trained action selection system can surpass that of the system including a scheduler neural network that can select the action selection system. It appears that training the action selection system, e.g. from scratch, using training data collected using the scheduling system may facilitate better final performance because the action selection system is less constrained than the scheduler neural network.

In implementations of the system include an action selection policy of the untrained or partly trained action selection system in the set of previously learned skills i.e. as one of the skill action selection subsystems. This facilitates good transfer of information from the previously learned skills, and also facilitates the trained action selection system improving beyond the previously learned skills. In implementations learning the skill length facilitates flexibility during training and can result in improved final performance.

In general implementations of the system can use reinforcement learning to learn tasks that other systems find difficult or impossible to learn, and can learn other tasks faster or using less computational resources than other some systems.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example of a training system for training an action selection system.

FIG. 2 is a flow diagram of an example process for training an action selection system.

FIG. 3 schematically illustrates an example of a data augmentation process.

FIG. 4 schematically illustrates an example implementation of the training system . . .

FIG. 5 illustrates use of a trained action selection system to perform a learned task.

FIG. 6 illustrates the performance of an example implementation of the training system.

Like reference numbers and designations in the various drawings indicate like elements.

### DETAILED DESCRIPTION

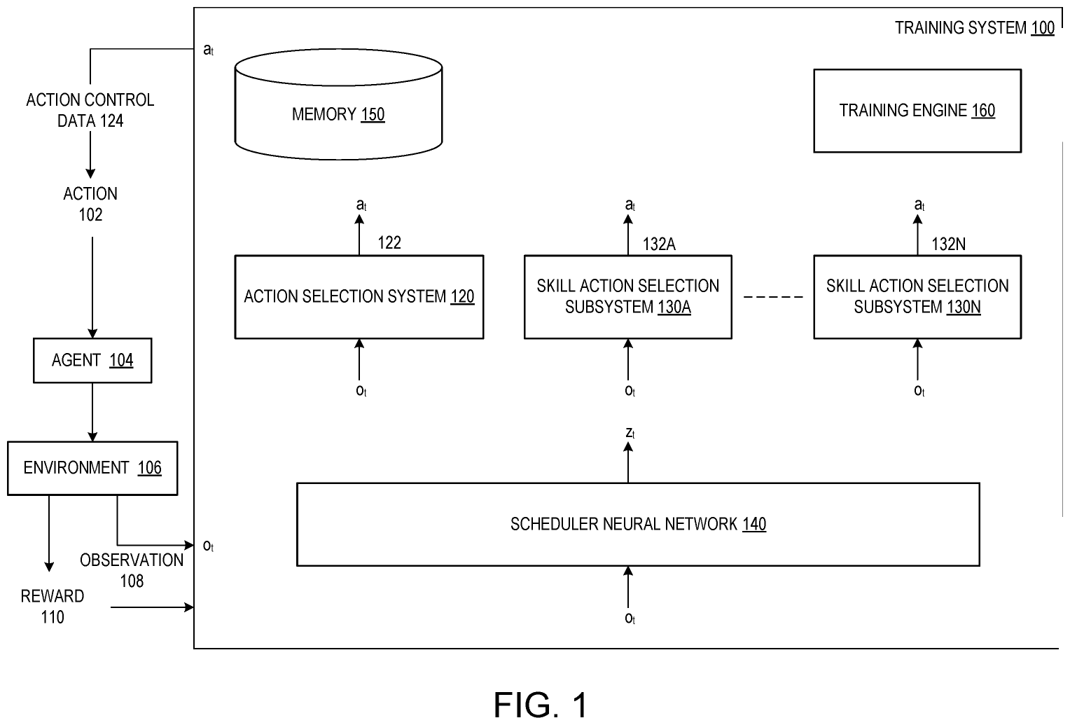

FIG. 1 shows an example of a training system 100 for training an action selection system 120, e.g. an action selection policy neural network. The training system 100 is an example of a system implemented as computer programs on one or more computers in one or more locations in which the systems, components, and techniques described below are implemented.

The action selection system 120 has an action selection system output 122 for selecting an action 102 of an agent 104, and is configured to process observations 108 that characterize states of an environment 106 to generate action control data 124 from the action selection system output 122. In implementations the action selection system 120 comprises an action selection neural network that is configured to process the observations, in accordance with action selection neural network learnable parameters, e.g. weights, to generate the action selection system output 122.

The action selection system 120 is trained to generate action control data 124 for controlling the actions 102 of the agent 104, so that the agent can perform a learned task in the environment 106. In some implementations the action control data can identify the action to be performed; in some implementations it may, e.g., define or parameterize a distribution from which, or using which, an action to be performed is chosen or sampled.

Once the agent 104 has performed a selected action, the environment 106 transitions into a new state and the system receives a reward. In general, the reward is a numerical value. The reward may indicate whether the agent 104 has accomplished the task, or the progress of the agent towards accomplishing the task. The reward can be based on any event in or aspect of the environment.

A reward may be dense, e.g. received at many (agent) action time steps, or sparse, e.g. received at only a few (agent) action time steps, or only at the end of a task, e.g. if the task is successfully completed. Some implementations of the described techniques are particularly beneficial when rewards are sparse. As an example, if the task specifies that the agent should stack multiple items, one top of another, a sparse reward may have a positive value when all the items are stacked and a zero value otherwise. As another example, if the task is for the agent to get up and walk, positive rewards may only be received after the agent has successfully got up.

Generally the action selection system 120 comprises an action selection neural network. In some implementations the action selection neural network may be, or may be trained as, part of a larger action selection system. For example the action selection neural network may be part of an actor-critic system that includes a critic neural network as well as the action selection neural network, or part of a system that uses a model to plan ahead e.g. based on simulations of the future.

In general the action selection neural network of the action selection system 120 can have any appropriate architecture, e.g., a convolutional architecture, a fully-connected architecture, a transformer architecture, or any other appropriate neural network architecture. It can include any appropriate types of neural network layers, e.g., one or more convolutional layers, (self)-attention layers, fully connected layers, or recurrent layers, and so forth, in any appropriate numbers, e.g., 10 layers, 100 layers, or 1000 layers, and connected in any appropriate configuration, e.g., as a linear sequence of layers or as a directed graph of layers.

The training system 100 also includes a set of skill action selection subsystems 130A . . . N. Each of these is configured, e.g. trained, to process an observation 108 characterizing a state of the environment, in accordance with a skill action selection policy, to generate a skill action selection output 132A . . . N. The skill action selection output 132A . . . N is used for selecting an action for the agent 104 to perform a respective skill task. A skill task is a task that the respective skill action selection subsystem has been configured to perform.

In some implementations each of the skill action selection subsystems 130A . . . N comprises a respective trained skill (action selection) neural network, and the skill action selection policy is defined by a respective set of skill neural network parameters, e.g. weights. In some implementations the set of skill action selection subsystems 130A . . . N may be implemented as a single trained skill neural network that can be conditioned on a skill identifier of a particular skill, so that the trained skill neural network then acts as a skill action selection subsystem for that particular skill.

The training system 100 further includes a scheduler neural network 140 that is configured to processing an observation 108 of a current state of the environment, in accordance with scheduler neural network learnable parameters, e.g. weights, to generate a scheduler action, zₜ, that selects one of the set of skill action selection subsystems, e.g. one of the skill neural networks. The scheduler may, e.g., output the scheduler action directly or may have an output that parameterizes a distribution from which the scheduler action is drawn. In some implementations, and as described further below, the scheduler action, zₜ, may also define a skill length.

In some implementations the action selection system 120 is also considered part of the set of skill action selection subsystems, since the learned task can be considered a new skill. In these implementations the action selection system 120 is one of the set of skill action selection subsystems that a scheduler action can select. Thus, in implementations where the action selection system 120 is used to control the agent to interact with the environment, it may do so only when it is selected the by the scheduler neural network 140.

Like the action selection neural network, in general the scheduler neural network can have any appropriate architecture, e.g., a convolutional architecture, a fully-connected architecture, a transformer architecture, or any other appropriate neural network architecture. It can include any appropriate types of neural network layers, e.g., one or more convolutional layers, (self)-attention layers, fully connected layers, or recurrent layers, and so forth, in any appropriate numbers.

Merely as an example implementation, one or more of the action selection neural network, a skill neural network, and the scheduler neural network may be implemented with Multilayer Perceptron (MLP) network torso and a network head output that provides mean and log standard deviation parameters of an isotropic Gaussian distribution from which the action is sampled.

The training system 100 also includes a memory 150, later also referred to as a replay buffer, configured to store training data for training the action selection system 120. In implementations the memory stores training data for each of a set of (agent) action time steps. For example, the training data for an (agent) action time step may comprising the observation (at the time step), the selected action 102, the subsequent observation (at the next time step), and the reward (which may be zero).

In general storing an observation or an action can refer to storing an encoded version of the observation or of the action, e.g. an observation embedding or an action embedding. As used herein an “embedding” of an entity can refer to a representation of the entity as an ordered collection of numerical values, e.g., a vector or matrix of numerical values, and may be generated as the output of a neural network that processes data characterizing the entity.

In implementations additional data may be stored in the memory 150. For example where the scheduler neural network 140 is trained using data in the memory scheduler actions, zₜ may be stored, either every (agent) action time step or every time a scheduler action is generated (in general less frequently than every (agent) action time step). As another example, in some implementations a count is stored that indexes each action time step of a skill i.e. that counts over the skill length.

The training system 100 also includes a training engine 160, that is configured to train the action selection system 120 and the scheduler neural network 140, as described later.

In broad terms the set of skill action selection subsystems is used to explore states of the environment to collect training data that is then used to train the action selection system.

In implementations the action selection system 120 and the scheduler neural network 140 are trained in parallel, so that the learning process of one can influence the learning process of the other. In some implementations, but not necessarily, the action selection system 120 and the scheduler neural network 140 are trained with the same objective, of maximizing the task reward. Alternatively, the scheduler neural network 140 may be trained with an objective that incentivizes exploration; this may improve the ability of the system to collect training data in environments where exploration is difficult.

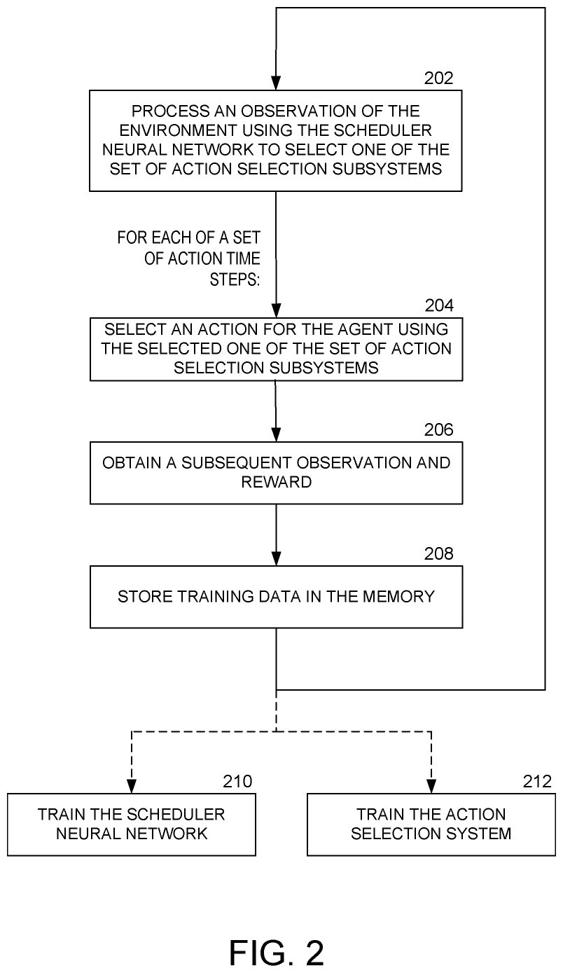

FIG. 2 is a flow diagram of an example process for training an action selection system, such as the action selection system 120 of FIG. 1. The process of FIG. 2 may be implemented by one or more computers in one or more locations, e.g. by the training engine 160. In implementations aspects of the training process may be performed in parallel with one another.

The process collects training data by obtaining and processing observations 108 of the environment. The observations are processed by the scheduler neural network 140 at scheduler action time steps, and by one of the skill action selection subsystems at (agent) action time steps. The observations processed by the scheduler neural network and by the skill action selection subsystems may, but need not be, the same observations.

At each scheduler action time step the scheduler neural network 140 processes the observation 108 that has been obtained of a current state of the environment 106. The scheduler neural network 140 generates a scheduler action that selects one of the skill action selection subsystems, e.g. one of the skill neural networks (step 202).

Starting with the scheduler action time step, the process collects training data for each of a set of (agent) action time steps. The first (agent) action time step may be the same time step as the scheduler action time step, i.e. the set of action time steps may begin with the scheduler time step.

For each of the (agent) action time steps, an observation, ot, 108 of the environment at the action time step, t, is obtained. The observation for the first (agent) action time step may be, but need not be, the same observation processed by the schedule neural network 140. The observation is processed using the selected one of the set of skill action selection subsystems, e.g. using a selected skill neural network, to select an action 102 to be performed by the agent (step 204).

The selected action is performed by the agent. At step 206, after the agent has performed the selected action the process obtains a subsequent observation 108 characterizing a subsequent state of the environment, and receives a reward for the (learned) task, the reward may be positive, negative (i.e. a cost), or zero. A majority of the rewards are zero when the rewards are sparse. The subsequent observation is used as the observation of the current state of the environment for the next (agent) action time step.

Training data for the (agent) action time step, comprising the observation, the selected action, the subsequent observation, and the reward, is stored in the memory 150 or “replay buffer” (step 208).

In implementations a trajectory is stored so that the subsequent observation is the same as the current observation for the next time step, i.e. except at the start and end only one of these need be stored. The set of (agent) action time steps may be considered to define a trajectory of observations and agent actions for a partial skill task, i.e. that relates to agent actions selected in accordance with performing part of a skill task the selected skill neural network has been trained to perform.

That is in some implementations the duration of execution of a skill is independent of the pre-trained length of the skill. This can provide improved performance, particularly on difficult tasks, and allows flexibility in the use of knowledge from the skill. In some other implementations the duration of execution of a skill may be the same as the pre-trained length of the skill.

After the process has collected training data for each of a set of (agent) action time steps, a next scheduler action is generated to make another selection of one of the skill neural networks, e.g. based on an observation of the then current state of the environment.

A fixed or variable skill length can define a number of time steps in the set of (agent) action time steps, i.e. a number of time steps for which the selected one of the set of selected skill action selection subsystems is used to select actions to be performed by the agent. Where the skill length is variable the scheduler action, zₜ, can define the skill length.

In some implementations the process can maintain a counter that counts over the skill length. This can be used, e.g. to determine when to generate the next scheduler action, and when training the scheduler neural network 140. For example, for a skill length k, the count can be initialized to c=k when the scheduler neural network 140 generates a scheduler action, and can be decremented at every (agent) action time step (cₜ₊₁=cₜ−1) until the chosen skill duration has been reached (c=0) and a new scheduler action is generated.

The process can repeatedly loop back to step 202, e.g. until the end of an episode. Here an episode is a series of interactions of the agent with the environment during which the agent attempts to perform a particular task. An episode may end, e.g., with a terminal state indicating whether or not the task was performed, or after a specified number of action-selection time steps.

In implementations the process collects the training data whilst keeping the skill action selection policies of each of the set of action selection subsystems 130A . . . N, e.g. the trained skill neural networks, unchanged. That is, where the skill action selection subsystems comprise trained skill neural networks, the skill neural network parameters of each of the set of trained skill neural networks may be frozen whilst collecting the training data (and generally throughout the method, e.g. also whilst training the scheduler neural network).

The scheduler neural network 140 is trained using reinforcement learning to optimize a scheduler (reinforcement learning) objective, typically dependent on the rewards received (step 210). The rewards can be received as a result of the agent performing the learned task in the environment and/or may comprise intrinsic rewards that reward exploration of the environment. For example the scheduler objective can be to maximize the rewards received for the (learned) task. The scheduler neural network 140 can be trained using the scheduler actions and on the observations and the rewards from the (agent) action time steps, in particular from each action time step. Any of a wide range of reinforcement learning techniques may be employed.

In implementations a wide range of scheduler objectives may be used. Generally the scheduler objective is based on an estimate of a “return” for the learned task, e.g. to maximize the return. Here a “return” is a cumulative measure of reward received by the system as the agent interacts with the environment over multiple time steps, such as a time-discounted reward received by the system. Merely some as examples, the scheduler objective may determine a Bellman error, or may use a policy gradient, based on the rewards.

The process can train the scheduler neural network 140 whilst collecting the training data or after collecting training data, e.g. using the training data stored in the memory 150 (which can then include the scheduler actions).

The action selection system 120, e.g. the action selection neural network, is trained using reinforcement learning, based on the training data stored in the memory 150, to generate action control data to control the agent to perform the learned task (step 212). Any of a wide range of reinforcement learning techniques may be employed.

The (reinforcement learning) objective can be to maximize the rewards received for the learned task. That is, in some implementations the scheduler neural network 140 and the action selection system 120 can be trained with the same objective of maximizing the rewards from the learned task.

For example the action selection system 120 can be trained using an off-policy or offline reinforcement learning technique, to optimize a reinforcement learning objective e.g. dependent on the stored rewards. Using an off-policy or offline reinforcement learning technique can be beneficial as the training data can be off-policy because of the way in which it is collected. For example even where the action selection system 120 is one of the set of skill action selection subsystems, initially it may only be selected rarely as may tend to provide lower rewards than the pre-trained skill action selection subsystems 130A . . . N.

In general the training of the scheduler neural network 140 and of the action selection system 120, may use any of a wide range of reinforcement learning techniques.

Training a neural network using a reinforcement learning technique can refer to iteratively adjusting values of learnable parameters, e.g. weights, of the neural network to encourage an increase in a cumulative measure of rewards received by the agent performing actions selected using the neural network. The cumulative measure of rewards can be, e.g., a time-discounted sum of rewards.

Training a neural network as described herein can involve backpropagating gradients of the objective to update learnable parameters of the neural network. This may use any appropriate gradient descent optimization algorithm, e.g. Adam or another optimization algorithm.

In general a training process as describe above can be performed iteratively, in particular in repeated phases of collecting training data using the skill action selection subsystems and the scheduler neural network, and then training the action selection system on the stored training data using (offline) reinforcement learning. Each of these phases may be referred to as a training phase. In general the training process can have a plurality of training phases.

Each training phase may comprise a first, exploration phase during which actions selected by the set of skill action selection subsystems are used to explore the states of the environment to collect training data, and a second, training phase during which the action selection system 120 is trained on the stored training data. In some implementations the second, training phase follows the first, exploration phase; in some implementations the second, training phase may be performed in parallel with the first, exploration phase. In some implementations the first, exploration phase may continue until the end of an episode.

As previously described, some implementations of the method use the action selection system 120 as one of the set of skill action selection subsystems, to select actions to be performed by the agent whilst collecting the training data, before training the action selection system offline on the stored training data. Then in some implementations, but not necessarily, an action selection policy of the action selection system 120 may be frozen whilst the training data is being collected, e.g. the action selection neural network learnable parameters may be frozen whilst the training data is being collected (during the exploration phase). If so, the action selection neural network learnable parameters are unfrozen prior to training the action selection neural network.

Initially the action selection neural network parameters, and the actions selected by the action selection neural network may be close to random. However as training progresses and the number of training phases increases, the action selection system 120 will gradually start to show useful behavior that can be incorporated into the training data collection by the scheduling neural network 140, to bootstrap the learning. For example, whilst the scheduling neural network may initially ignore or rarely use the action selection system 120 as one of the skill action selection subsystems, by the end of the training it may be the most frequently selected skill.

As previously described, in some implementations of the method the scheduler action also selects a skill length that defines a number of time steps in the set of (agent) action time steps for which the selected skill action selection subsystem is used to select actions to be performed by the agent. Selecting the skill length may include processing the observation of a current state of the environment using the scheduler neural network 140 to select the skill length, k, and setting the number of time steps in the set of (agent) action time steps as the selected skill length. That is, in implementations the scheduler neural network (rather than the selected skill action selection subsystem) determines when use of the selected skill action selection subsystem to select actions for the agent should end.

In general the scheduler neural network can select skill lengths for “partial skills” i.e. typically the skill length is shorter than a number of (agent) action time steps that the selected skill action selection subsystem would need to perform its skill task.

In some implementations the scheduler neural network 140 is trained on the stored training data. Then the method may include storing, in the memory 140, training data (for each (agent) action time step) that includes the scheduler action, and in implementations a count that indexes each (agent) action time step of the set of (agent) action time steps, e.g. as previously described.

The scheduler neural network may then be trained on the stored training data for each (agent) action time step, in particular the observation for the time step, the reward for the time step, the scheduler action for the time step (which is constant over the skill length), the count for the (agent) time step, and the observation for the next (agent) time step.

Including the count in the training data provides a value that changes every (agent) action time step whilst the scheduler action remains unchanged, and in implementations can facilitate training the scheduler neural network. For example including the count in the training data can facilitate training a Q-value (critic) neural network as described later. In implementations the scheduler neural network 140 is trained using data at the granularity of the action time steps.

In some implementations, but not necessarily, training the scheduler neural network involves training a Q-value neural network, i.e. a state-scheduler-action value neural network, that is configured to process the observation, the scheduler action (selection of one of the set of skill action selection subsystems), the selected skill length, and the count, to generate a Q-value, i.e. a value for the combination of the state (observation) and the scheduler action.

The Q-value can be an estimate of a “return” that would result from the agent when the scheduler neural network 140 performs the scheduler action in response to the current observation (thereafter selecting future actions performed by the agent at (agent) action time steps in accordance with an action selection policy defined by a combination of the scheduler neural network and the set of skill action selection subsystems).

The Q-value neural network may be trained using any Q-learning method. The scheduler neural network 140 can be trained using the Q-value neural network, e.g. using a scheduler objective that depends on a Q-value output of the Q-value neural network.

Training the Q-value neural network can use a target Q-value that, at an action time step corresponding to a scheduler time step, depends on a schedule action sampled using the scheduler neural network 140, and that depends on a current scheduler action otherwise.

Merely as one example the scheduler neural network can be trained using a Maximum a posteriori Policy Optimization type of reinforcement learning method (MPO, Abdolmaleki et al. 2018). Such training involves training a Q-value neural network, determining a “non-parametric” (i.e. not using a neural network) improvement to an action-selection policy of the scheduler neural network 140, where the non-parametric improvement is defined by the Q-value neural network, e.g. defined by exp (Q/η) where η is a temperature parameter. The scheduler neural network 140 can then be trained to generate scheduler actions with a distribution that match the improved action-selection policy, generally subject to a constraint, e.g. a KL (Kullback-Leibler) divergence constraint.

As one particular example, for a scheduler action zₜ=[iₜ; kₜ], where it indexes one of the set of skill action selection subsystems, kₜ defines the skill length, and t is an action time step, and a Q-value from a Q-value neural network associated with the scheduler neural network 140 may be denoted Q (oₜ, cₜ, iₜ, kₜ). That is the Q-value depends on the current observation at the (agent) action time step, the scheduler action, and the count (which decrements each (agent) action time step).

If at t+1 the scheduler neural network 140 has chosen a new action (cₜ₊₁=1) the target is evaluated using a scheduler action sampled from the scheduler neural network 140 (i, k˜πₛ(i; k|oₜ₊₁)), a Q-value update, i.e. target value for training the Q-value neural network (critic), may be defined according to:

$$Q ( {o}_{t} , {c}_{t} , {i}_{t} , {k}_{t} ) ← {r}_{t} + {γ𝔼}_{{π}_{S} ( i ; k \vert {o}_{t + 1} )} [ Q ( {o}_{t + 1} , {c}_{t + 1} , i , k ) ]$$

where rₜ is the reward at (agent) action time step t, γ is a discount factor, Q(·) is a Q-value generated by the Q-value neural network, πₛ(·) denotes a scheduler action selection policy of the scheduler neural network 140, and the expectation [symbol] πₛ(i; k|oₜ₊₁) may be determined as a single sample or as an average of multiple samples from the scheduler neural network 140. Otherwise the target is evaluated using the scheduler action, zₜ₊₁, actually taken by the scheduler neural network 140, i.e. zₜ₊₁=zₜ=[iₜ; kₜ] and the Q-value update, i.e. the target value for training the Q-value neural network (critic), may be defined according to:

$$Q ( {o}_{t} , {c}_{t} , {i}_{t} , {k}_{t} ) ← {r}_{t} + γ Q ( {o}_{t + 1} , {c}_{t + 1} = {c}_{t} - 1 , {i}_{t + 1} = {i}_{t} , {k}_{t + 1} = {k}_{t} )$$

This takes into account that when kₜ (agent) action time steps have passed the counter expires at cₜ=0 and a new scheduler action zₜ=[iₜ; kₜ] is chosen at time t, and that otherwise the previous action zₜ=zₜ₋₁=[iₜ₋₁; kₜ₋₁] is maintained.

Updating the Q-value neural network in this way can be referred to as a policy evaluation. After the policy evaluation a policy improvement step can be performed, to improve an action-selection policy of the scheduler neural network 140 using the updated Q-value. In general such a training process can involve alternating the policy evaluation and policy improvement steps.

As one particular example, a policy improvement step can involve determining a non-parametric improvement to a scheduler action-selection policy of the scheduler neural network 140 as q(z|o)∝πₛ(z|o) exp (Q (o, c=1, z)) where o denotes n observation characterizing a state of the environment. For example the scheduler neural network 140 may be trained to maximize an objective based on q (z|o) log πₛ(z|o), e.g. using a gradient update for the scheduler neural network 140 determined from a gradient of q(z|o) log πₛ(z|o), e.g. summed or averaged over a batch of observations from the training data and over the scheduler actions, selecting only transitions where a new action is sampled by the schedule neural network 140.

In implementations the scheduler neural network 140 may also be trained to minimize a KL divergence between the original and updated scheduler action distributions, e.g. by including a loss term in the training objective based on the KL divergence between the original and updated scheduler action distributions.

Training the action selection system 120, e.g. the action selection neural network, on the stored training data may comprise training the action selection system, e.g. using an offline reinforcement learning technique such as critic regularized regression (CRR, Wang et al. 2020), or an off-policy reinforcement learning technique such as MPO (ibid).

Optionally the collected training data can be augmented to generate additional scheduler actions. This can involve dividing the collected training data for one of the sets of (agent) action time steps (each having the same corresponding scheduler action), into a plurality of subsets of action time steps, each subset of action time steps having the same corresponding scheduler action.

A correspondingly shortened skill length can also be defined for each of the subsets of action time steps e.g. the number of action time steps in the set of action time steps (the skill length) divided by n, where n is the number of subsets. The count for each subset of time steps may also be modified in the collected training data, in particular to count up to the shortened skill length defined by that subset of time steps, e.g. the skill length divided by n (where n is an integer).

In implementations the training data for the original set of action time steps may also be retained, e.g. the training data for the set of action time steps may be duplicated and then divided. The process may be performed for multiple sets of (agent) action time steps. This effectively generates multiple scheduler actions where there was previously only one, creating more scheduler actions than were in fact present.

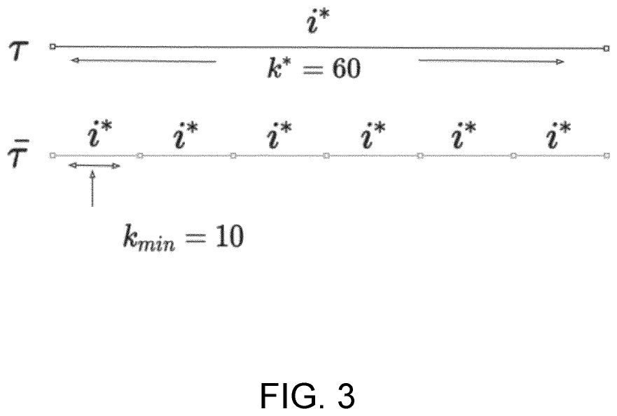

FIG. 3 schematically illustrates an example of such a data augmentation process. In FIG. 3 a trajectory of training data t has agent actions determined by a selected one, i*, of the set of skill action selection subsystems for a skill length of k*=60 (agent) action time steps. This is duplicated as a trajectory of training data 7 with 6 scheduler actions rather than just one, each notionally the same. A value, kₘᵢₙ, may be defined that denotes the shortened skill length (in the example of FIG. 3 kₘᵢₙ=10), and a duplicated trajectory τ̅ may be created whenever a trajectory t has a skill length that is an integer multiple of kₘᵢₙ. Both τ and τ̅ can be included in the replay buffer, i.e. memory 150, and used for training the scheduler neural network 140.

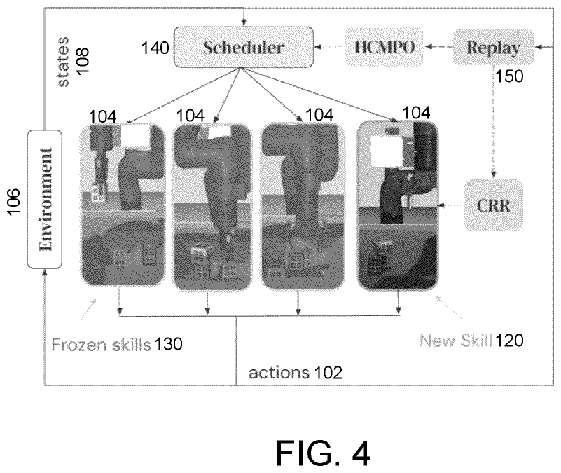

FIG. 4 schematically illustrates an example implementation of the above described training system and method. In FIG. 4 the agent 102 comprises a robot; the scheduler neural network training process is denoted HCMPO, and the action selection system 120 training process is denoted CRR.

After the action selection system 120 has been trained it can be used to control the agent to perform the learned task without the skill action selection subsystems 130A . . . N, and without the scheduler neural network 140. That is, in implementations of the method the action selection system is trained to perform the learned task independently of the set of skill action selection subsystems 130A . . . N and the scheduler neural network 140.

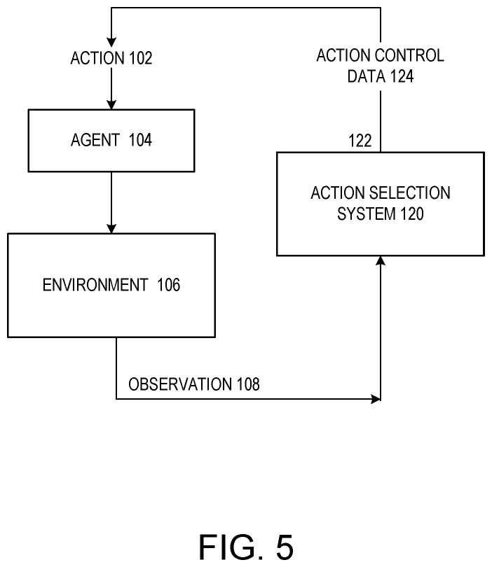

FIG. 5 illustrates use of the trained action selection system 120 to perform the learned task. The action selection system 120, which may be implemented as computer programs on one or more computers in one or more locations, obtains observations 108 of the environment 106, and processes the observations to generate action control data 124 that is used to control the actions 102 of the agent 104 to perform the learned task.

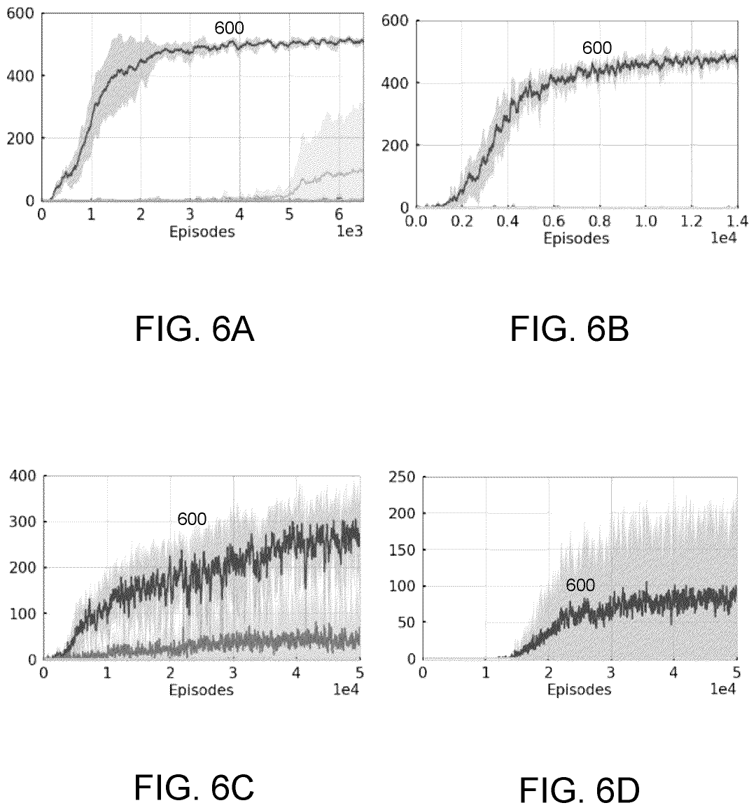

FIG. 6 illustrates the performance of an example implementation of the above described techniques. More particularly FIG. 6 shows graphs of performance measured as accumulated reward on the y-axis against the number of episodes used for training on the x-axis. The learned tasks relate to the control of a simulated Sawyer robot arm equipped with Robotiq gripper and all provide only sparse rewards. In FIG. 6A the task is to lift an object; in FIG. 6B the task is to stack two objects; in FIG. 6C the task is to build a pyramid of objects; in FIG. 6D the task is to stack three objects. In each graph curve 600 shows the performance of an implementation of the above described technique whilst the other curves show the performance of other skill reuse methods (in many cases the other methods fail and are flat lines in the plot). It can be seen the implementation of the described technique is the only one that consistently learns across all the tasks. The skills used for the example tasks of FIG. 6 are shown in the table below, where the “Useful skills” column gives examples of the skills used, the “No.” column gives the total number of skills used, and the three objects are denoted “green”, “yellow” and “blue”. Each successive task also includes the previous task solution as a skill, e.g. the stack two objects task had “lift an object” as a skill.

| Task | Useful skills | No. |
|---|---|---|
| Lift | Reach green, | 2 |
| (green) | Lift arm with closed fingers | |
| Stack | Useful skills for Lift green, | 4 |
| (green on yellow) | Lift green, | |
| | Hover green on yellow | |
| Pyramid | Useful skills for Stack, | 9 |
| (green on top) | Stack green on yellow, | |
| | Lift yellow, Lift blue | |
| | Reach yellow, Reach blue | |
| Triple stacking | Useful skills for Stack, | 9 |
| (green on yellow | Stack green on yellow, | |
| on blue) | Stack yellow on blue, | |
| | Lift yellow, Reach yellow, | |
| | Hover yellow on blue, | |

Some example rewards that can be used in such tasks are given below:
Reach object—dense

$${R}_{reach} = \{ \begin{matrix}1 & iff ‖ \frac{{p}_{gripper} - {p}_{object}}{{tol}_{pos}} ‖ \leq 1 \\ 1 - {tanh}^{2} ( ‖ \frac{{p}_{gripper} - {p}_{object}}{{tol}_{pos}} ‖ \cdot ϵ ) & otherwise ,\end{matrix}$$

where p_{gripper}∈R³ is the position of the gripper, p_{object}∈R³ the position of the object, tolₚₒₛ=[0.055, 0.055, 0.02]m the tolerance in position and ϵ a scaling factor.
Open fingers—dense

$${R}_{open} = \{ \begin{matrix}1 & iff ‖ \frac{{p}_{finger} - {p}_{desired}}{{tol}_{pos}} ‖ \leq 1 \\ 1 - {tanh}^{2} ( ‖ \frac{{p}_{finger} - {p}_{desired}}{{tol}_{pos}} ‖ \cdot ϵ ) & otherwise ,\end{matrix}$$

where p_{finger}∈R is the angle of aperture of the gripper, p_{desired}∈R is the angle corresponding to the open position, tolₚₒₛ=1e⁻⁹ the tolerance in position and e a scaling factor.
Lift arm with open fingers—dense

$${R}_{lift} = \{ \begin{matrix}1 & iff {z}_{arm} \geq {z}_{desired} \\ \frac{{z}_{arm} - {z}_{min}}{{z}_{desired} - {z}_{min}} & otherwise\end{matrix} ,$$

where zₐᵣₘ∈R is the z-coordinate of the position of the gripper, zₘᵢₙ=0.08 ∈R is the minimum height the arm should lift to receive non-zero reward and z_{desired}=0.18 ∈R is the desired z-coordinate the position of the gripper should reach to get maximum reward. The reward to have both the arm moving up and the fingers open is given by:

$${R}_{lift , open} = {R}_{lift} \cdot {R}_{open} .$$

Lift arm with closed fingers-dense

$${R}_{grasp} = 0.5 ( {R}_{closed} + {R}_{grasp , aux} ) ,$$

where R_{closed} is computed with the formula of Eq. equation 17, but using as p_{desired}∈R the angle corresponding to closed fingers this time;

$${R}_{grasp , aux} = \{ \begin{matrix}1 & if grasp detected by the grasp sensor \\ 0 & otherwise\end{matrix} .$$

Then the final reward is:

$${R}_{lift , closed} = {R}_{lift} \cdot {R}_{group} .$$

Lift object—sparse

$${R}_{lift} = \{ \begin{matrix}1 & iff {z}_{object} \geq {z}_{desired} \\ 0 & otherwsie\end{matrix} ,$$

where z_{object}∈R is the z-coordinate of the position of the object to lift and z_{desired}=0.18 the desired z-coordinate the object should reach to get maximum reward.
Hover object on another one—dense

$${R}_{hover} = \{ \begin{matrix}1 & iff ‖ \frac{{p}_{top} - {p}_{bottom} - offset}{{tol}_{pos}} ‖ \leq 1 \\ 1 - {tanh}^{2} ( ‖ \frac{{p}_{top} - {p}_{bottom} - offset}{{tol}_{pos}} ‖ \cdot ϵ ) & otherwise\end{matrix} ,$$

where pₜₒₚ∈R³ is the position of the top object, p_{bottom}∈R³ the position of the bottom object, offset=[0, 0, object_{height}=0.04], tolₚₒₛ=[0.055, 0.055, 0.02]m the tolerance in position and e a scaling factor.
Stack top object on bottom object—sparse

$${R}_{stock} = \{ \begin{matrix}1 & iff {d}_{x , y} ( {p}_{top} , {p}_{bottom} ) \leq {tol}_{x , y} \& \\ & \vert {d}_{z} ( {p}_{top} , {p}_{bottom} ) - {d}_{desired} \vert \leq {tol}_{z} \& \\ & {R}_{grasp , aux} = 0 \\ 0 & otherwise\end{matrix} ,$$

where d_{x,y}(·, ·)∈R is the norm of the distance of 2D vectors (on x and y), d_{z}(·, ·)∈R is the (signed) distance along the z-coordinate, pₜₒₚ∈R³ and p_{bottom}∈R³ are respectively the position of the top and bottom object, tol_{x,y}=0.03 and tol_{z}=0.01 are the tolerance used to check if the stacking is achieved, d_{desired}=0.04 is obtained as the average of the side length of the top and bottom cubes. The final reward we use for stacking is:

$${R}_{stack , leave} = {R}_{stack} \cdot ( 1 - {R}_{reach , sparse} ( top ) )$$

where R_{reach,sparse}(top) is the sparse version of R_{reach} for the top object.
Pyramid—sparse

$${R}_{pyramid} = \{ \begin{matrix}1 & iff {d}_{x , y} ( {p}_{bottom , a} , {p}_{bottom , b} ) \leq {tol}_{x , y , bottom} \& \\ & {d}_{x , y} ( {p}_{top} , {p}_{bottom} ) \leq {tol}_{x , y} \& \\ & \vert {d}_{z} ( {p}_{top} , {p}_{bottom} ) - {d}_{desired} \vert \leq {tol}_{z} \& \\ & {R}_{grasp , aux} = 0 \\ 0 & otherwise\end{matrix} ,$$

where d_{x,y}(·, ·)∈R is the norm of the distance of 2D vectors (on; and y), d_{z}=(·, ·)∈R is the (signed) distance along the z-coordinate, pₜₒₚ, p_{bottom,a}, P_{bottom,b}∈R³ are respectively the position of the top object and the 2 bottom objects, while

$${p}_{bottom} = \frac{{p}_{bottom , a} + {p}_{bottom , b}}{2} ∈$$

R³ is the average position of the two bottom objects, tol_{x,y,bottom}=0.08, tol_{x,y}=0.03 and tol_{z}=0.01 are the tolerance used to check if the pyramid configuration is achieved, d_{desired}=0.04 is obtained as the average of the side length of the top and bottom cubes. The final reward we use for our tasks is:

$${R}_{pyramid , leave} = {R}_{pyramid} \cdot ( 1 - {R}_{reach , sparse} ( top ) ) .$$

Triple stacking—sparse The triple stacking reward is given by:

$${R}_{triple , stack , leave} = {R}_{stack} ( top , middle ) \cdot {R}_{stack} ( middle , bottom ) \cdot ( 1 - {R}_{reach , sparse} ( top ) ) .$$

In an example GetUpAndWalk task a humanoid robot (the “Robotis OP3”) is required to compose two skills, one to get up off of the floor and one to walk; a dense walking reward is given, but only if the robot is standing. Episodes are typically initiated with the robot lying prone on the ground, resulting in effective sparsity as the robot needs to get up before rewards can be earned from walking. In this example the behavior of the robot is conditioned on a goal observation (a 2-d unit target orientation vector), and a target speed in m/s. The reward per time step is a weighted sum R_{walk}:
GetUpAndWalk

$${R}_{w a l k} = {R}_{o r i e n t} + {R}_{v elocity} + {R}_{upright} + {R}_{action} + {R}_{pose} + {R}_{ground} + 1 ,$$

where Rₒᵣᵢₑₙₜ is the dot product between the target orientation vector and the robot's current heading: R_{velocity} is the norm of the difference between the target velocity, and the observed planar velocity of the feet; R_{upright} is 1.0 when the robot's orientation is close to vertical, decaying to zero outside a margin of 12.5°; R_{action} penalizes the squared angular velocity of the output action controls averaged over all 20 joints,

$${Σ}_{j o i n t} {( {ω}_{t}^{j o i n t} - {ω}_{t - 1}^{joint} )}^{2} ;$$

Rₚₒₛₑ regularizes the observed joint angles toward a reference “standing” pose

$${Σ}_{joint} {( {θ}^{joint} - {θ}_{r e f}^{joint} )}^{2} ;$$

and R_{ground}=−2 whenever the robot brings body parts other than the feet within 4 cm of the ground.

In an example GoalScoring task the robot is placed in a 4 m×4 m walled arena with a soccer ball. It must remain in its own half of the arena, and it scores goals when the ball enters a goal area, 0.5 m×1 m, positioned against the center of the back wall in the other half. An obstacle (a short stretch of wall) is placed randomly between the robot and the goal. An example GorlScoring reward is:
GoalScoring

$${R}_{g o a l s c o r i n g} = {R}_{score} + {R}_{upright} + {R}_{maxvelocity}$$

where: R_{score} is 1000 on the single timestep where the ball enters the goal region (and then becomes unavailable until the ball has bounced back to the robot's own half); R_{maxvelocity} is the norm of the planar velocity of the robot's feet in the robot's forward direction; R_{upright} is the same as for GetUpAndWalk. Additionally, episodes are terminated with zero reward if the robot leaves its own half, or body parts other than the feet come within 4 cm of the ground.

In some implementations the observations relate to a real-world environment, and the selected actions relate to actions to be performed by a mechanical agent, e.g. a robot. For example the training of the action selection system could be performed in the real-world environment or in a simulation of a real-world environment. The method may then use the trained (or partially trained) action selection system in the real-world to perform the learned task (which may include continuing to learn the task in the real-world environment). Thus the method also comprises using the action selection system to control the mechanical agent to perform the learned task while interacting with a real-world environment, by obtaining observations from one or more sensors sensing the real-world environment, processing the obtained observations using the action selection system to generate the action control data, and using the action control data to select actions to control the mechanical agent to perform the learned task. For example the learned task may be to move the agent or a part of the agent, e.g. to navigate in the environment and/or to move a part of the agent such as a robot arm e.g. to move or manipulate the agent or an object in three dimensions.

As mentioned, in some implementations the environment is a real-world environment, the agent is a mechanical agent interacting with the real-world environment, e.g., a robot or an autonomous or semi-autonomous land, air, or sea vehicle operating in or navigating through the environment, and the actions are actions taken by the mechanical agent in the real-world environment to perform the task. For example, the agent may be a robot interacting with the environment to accomplish a specific task, e.g., to locate or manipulate an object of interest in the environment or to move an object of interest to a specified location in the environment or to navigate to a specified destination in the environment.

In these implementations, the observations may include, e.g., one or more of: images, object position data, and sensor data to capture observations as the agent interacts with the environment, for example sensor data from an image, distance, or position sensor or from an actuator. For example in the case of a robot, the observations may include data characterizing the current state of the robot, e.g., one or more of: joint position, joint velocity, joint force, torque or acceleration, e.g., gravity-compensated torque feedback, and global or relative pose of an item held by the robot. In the case of a robot or other mechanical agent or vehicle the observations may similarly include one or more of the position, linear or angular velocity, force, torque or acceleration, and global or relative pose of one or more parts of the agent. The observations may be defined in 1, 2 or 3 dimensions, and may be absolute and/or relative observations. The observations may also include, for example, sensed electronic signals such as motor current or a temperature signal; and/or image or video data for example from a camera or a LIDAR sensor, e.g., data from sensors of the agent or data from sensors that are located separately from the agent in the environment.

In these implementations, the actions may be control signals to control the robot or other mechanical agent, e.g., torques for the joints of the robot or higher-level control commands, or the autonomous or semi-autonomous land, air, sea vehicle, e.g., torques to the control surface or other control elements e.g. steering control elements of the vehicle, or higher-level control commands. The control signals can include for example, position, velocity, or force/torque/acceleration data for one or more joints of a robot or parts of another mechanical agent. The control signals may also or instead include electronic control data such as motor control data, or more generally data for controlling one or more electronic devices within the environment the control of which has an effect on the observed state of the environment. For example in the case of an autonomous or semi-autonomous land or air or sea vehicle the control signals may define actions to control navigation e.g. steering, and movement e.g., braking and/or acceleration of the vehicle.

In some implementations the environment is a simulation of the above-described real-world environment, and the agent is implemented as one or more computers interacting with the simulated environment. For example the simulated environment may be a simulation of a robot or vehicle and the reinforcement learning system may be trained on the simulation and then, once trained, used in the real-world.

In some implementations the environment is a real-world manufacturing environment for manufacturing a product, such as a chemical, biological, or mechanical product, or a food product. As used herein a “manufacturing” a product also includes refining a starting material to create a product, or treating a starting material e.g. to remove pollutants, to generate a cleaned or recycled product. The manufacturing plant may comprise a plurality of manufacturing units such as vessels for chemical or biological substances, or machines, e.g. robots, for processing solid or other materials. The manufacturing units are configured such that an intermediate version or component of the product is moveable between the manufacturing units during manufacture of the product, e.g. via pipes or mechanical conveyance. As used herein manufacture of a product also includes manufacture of a food product by a kitchen robot.

The agent may comprise an electronic agent configured to control a manufacturing unit, or a machine such as a robot, that operates to manufacture the product. That is, the agent may comprise a control system configured to control the manufacture of the chemical, biological, or mechanical product. For example the control system may be configured to control one or more of the manufacturing units or machines or to control movement of an intermediate version or component of the product between the manufacturing units or machines.

As one example, a task performed by the agent may comprise a task to manufacture the product or an intermediate version or component thereof. As another example, a task performed by the agent may comprise a task to control, e.g. minimize, use of a resource such as a task to control electrical power consumption, or water consumption, or the consumption of any material or consumable used in the manufacturing process.

The actions may comprise control actions to control the use of a machine or a manufacturing unit for processing a solid or liquid material to manufacture the product, or an intermediate or component thereof, or to control movement of an intermediate version or component of the product within the manufacturing environment e.g. between the manufacturing units or machines. In general the actions may be any actions that have an effect on the observed state of the environment, e.g. actions configured to adjust any of the sensed parameters described below. These may include actions to adjust the physical or chemical conditions of a manufacturing unit, or actions to control the movement of mechanical parts of a machine or joints of a robot. The actions may include actions imposing operating conditions on a manufacturing unit or machine, or actions that result in changes to settings to adjust, control, or switch on or off the operation of a manufacturing unit or machine.

The rewards or return may relate to a metric of performance of the task. For example in the case of a task that is to manufacture a product the metric may comprise a metric of a quantity of the product that is manufactured, a quality of the product, a speed of production of the product, or to a physical cost of performing the manufacturing task, e.g. a metric of a quantity of energy, materials, or other resources, used to perform the task. In the case of a task that is to control use a resource the matric may comprise any metric of usage of the resource.

In general observations of a state of the environment may comprise any electronic signals representing the functioning of electronic and/or mechanical items of equipment. For example a representation of the state of the environment may be derived from observations made by sensors sensing a state of the manufacturing environment, e.g. sensors sensing a state or configuration of the manufacturing units or machines, or sensors sensing movement of material between the manufacturing units or machines. As some examples such sensors may be configured to sense mechanical movement or force, pressure, temperature; electrical conditions such as current, voltage, frequency, impedance; quantity, level, flow/movement rate or flow/movement path of one or more materials; physical or chemical conditions e.g. a physical state, shape or configuration or a chemical state such as pH; configurations of the units or machines such as the mechanical configuration of a unit or machine, or valve configurations; image or video sensors to capture image or video observations of the manufacturing units or of the machines or movement; or any other appropriate type of sensor. In the case of a machine such as a robot the observations from the sensors may include observations of position, linear or angular velocity, force, torque or acceleration, or pose of one or more parts of the machine, e.g. data characterizing the current state of the machine or robot or of an item held or processed by the machine or robot. The observations may also include, for example, sensed electronic signals such as motor current or a temperature signal, or image or video data for example from a camera or a LIDAR sensor. Sensors such as these may be part of or located separately from the agent in the environment.

In some implementations the environment is the real-world environment of a service facility comprising a plurality of items of electronic equipment, such as a server farm or data center, for example a telecommunications data center, or a computer data center for storing or processing data, or any service facility. The service facility may also include ancillary control equipment that controls an operating environment of the items of equipment, for example environmental control equipment such as temperature control e.g. cooling equipment, or air flow control or air conditioning equipment. The task may comprise a task to control, e.g. minimize, use of a resource, such as a task to control electrical power consumption, or water consumption. The agent may comprise an electronic agent configured to control operation of the items of equipment, or to control operation of the ancillary, e.g. environmental, control equipment.

In general the actions may be any actions that have an effect on the observed state of the environment, e.g. actions configured to adjust any of the sensed parameters described below. These may include actions to control, or to impose operating conditions on, the items of equipment or the ancillary control equipment, e.g. actions that result in changes to settings to adjust, control, or switch on or off the operation of an item of equipment or an item of ancillary control equipment.

In general observations of a state of the environment may comprise any electronic signals representing the functioning of the facility or of equipment in the facility. For example a representation of the state of the environment may be derived from observations made by any sensors sensing a state of a physical environment of the facility or observations made by any sensors sensing a state of one or more of items of equipment or one or more items of ancillary control equipment. These include sensors configured to sense electrical conditions such as current, voltage, power or energy; a temperature of the facility; fluid flow, temperature or pressure within the facility or within a cooling system of the facility; or a physical facility configuration such as whether or not a vent is open.

The rewards or return may relate to a metric of performance of the task. For example in the case of a task to control, e.g. minimize, use of a resource, such as a task to control use of electrical power or water, the metric may comprise any metric of use of the resource.

In some implementations the environment is the real-world environment of a power generation facility e.g. a renewable power generation facility such as a solar farm or wind farm. The task may comprise a control task to control power generated by the facility, e.g. to control the delivery of electrical power to a power distribution grid, e.g. to meet demand or to reduce the risk of a mismatch between elements of the grid, or to maximize power generated by the facility. The agent may comprise an electronic agent configured to control the generation of electrical power by the facility or the coupling of generated electrical power into the grid. The actions may comprise actions to control an electrical or mechanical configuration of an electrical power generator such as the electrical or mechanical configuration of one or more renewable power generating elements e.g. to control a configuration of a wind turbine or of a solar panel or panels or mirror, or the electrical or mechanical configuration of a rotating electrical power generation machine. Mechanical control actions may, for example, comprise actions that control the conversion of an energy input to an electrical energy output, e.g. an efficiency of the conversion or a degree of coupling of the energy input to the electrical energy output. Electrical control actions may, for example, comprise actions that control one or more of a voltage, current, frequency or phase of electrical power generated.

The rewards or return may relate to a metric of performance of the task. For example in the case of a task to control the delivery of electrical power to the power distribution grid the metric may relate to a measure of power transferred, or to a measure of an electrical mismatch between the power generation facility and the grid such as a voltage, current, frequency or phase mismatch, or to a measure of electrical power or energy loss in the power generation facility. In the case of a task to maximize the delivery of electrical power to the power distribution grid the metric may relate to a measure of electrical power or energy transferred to the grid, or to a measure of electrical power or energy loss in the power generation facility.

In general observations of a state of the environment may comprise any electronic signals representing the electrical or mechanical functioning of power generation equipment in the power generation facility. For example a representation of the state of the environment may be derived from observations made by any sensors sensing a physical or electrical state of equipment in the power generation facility that is generating electrical power, or the physical environment of such equipment, or a condition of ancillary equipment supporting power generation equipment. Such observations may thus include observations of wind levels or solar irradiance, or of local time, date, or season. Such sensors may include sensors configured to sense electrical conditions of the equipment such as current, voltage, power or energy; temperature or cooling of the physical environment; fluid flow; or a physical configuration of the equipment; and observations of an electrical condition of the grid e.g. from local or remote sensors. Observations of a state of the environment may also comprise one or more predictions regarding future conditions of operation of the power generation equipment such as predictions of future wind levels or solar irradiance or predictions of a future electrical condition of the grid.

As another example, the environment may be a chemical synthesis or protein folding environment such that each state is a respective state of a protein chain or of one or more intermediates or precursor chemicals and the agent is a computer system for determining how to fold the protein chain or synthesize the chemical. In this example, the actions are possible folding actions for folding the protein chain or actions for assembling precursor chemicals/intermediates and the result to be achieved may include, e.g., folding the protein so that the protein is stable and so that it achieves a particular biological function or providing a valid synthetic route for the chemical. As another example, the agent may be a mechanical agent that indirectly performs or controls the protein folding actions, e.g. by controlling chemical synthesis steps selected by the system automatically without human interaction. The observations may comprise direct or indirect observations of a state of the protein or chemical/intermediates/precursors and/or may be derived from simulation. Thus the system may be used to automatically synthesize a protein with a particular function such as having a binding site shape, e.g. a ligand that binds with sufficient affinity for a biological effect that it can be used as a drug. For example e.g. it may be an agonist or antagonist of a receptor or enzyme; or it may be an antibody configured to bind to an antibody target such as a virus coat protein, or a protein expressed on a cancer cell, e.g. to act as an agonist for a particular receptor or to prevent binding of another ligand and hence prevent activation of a relevant biological pathway.

In a similar way the environment may be a drug design environment such that each state is a respective state of a potential pharmaceutically active compound pharmaceutically active compound and the agent is a computer system for determining elements of the pharmaceutically active compound and/or a synthetic pathway for the pharmaceutically active compound. The drug/synthesis may be designed based on a reward derived from a target for the pharmaceutically active compound, for example in simulation. As another example, the agent may be a mechanical agent that performs or controls synthesis of the pharmaceutically active compound.

In some applications the agent may be a software agent i.e. a computer program, configured to perform a task. For example the environment may be a circuit or an integrated circuit design or routing environment and the agent may be configured to perform a design or routing task for routing interconnection lines of a circuit or of an integrated circuit e.g. an ASIC. The reward(s) may then be dependent on one or more routing metrics such as interconnect length, resistance, capacitance, impedance, loss, speed or propagation delay; and/or physical line parameters such as width, thickness or geometry, and design rules. The reward(s) may also or instead include one or more reward(s) relating to a global property of the routed circuitry e.g. component density, operating speed, power consumption, material usage, a cooling requirement, level of electromagnetic emissions, and so forth. The observations may be e.g. observations of component positions and interconnections; the actions may comprise component placing actions e.g. to define a component position or orientation and/or interconnect routing actions e.g. interconnect selection and/or placement actions. The method may include making the circuit or integrated circuit to the design, or with interconnection lines routed as determined by the method.

In some applications the agent is a software agent and the environment is a real-world computing environment. In one example the agent manages distribution of tasks across computing resources e.g. on a mobile device and/or in a data center. In these applications, the observations may include observations of computing resources such as compute and/or memory capacity, or Internet-accessible resources; and the actions may include assigning tasks to particular computing resources. The reward(s) may be configured to maximize or minimize one or more of: utilization of computing resources, electrical power, bandwidth, and computation speed.

In another example the software agent manages the processing, e.g. by one or more real-world servers, of a queue of continuously arriving jobs. The observations may comprise observations of the times of departures of successive jobs, or the time intervals between the departures of successive jobs, or the time a server takes to process each job, e.g. the start and end of a range of times, or the arrival times, or time intervals between the arrivals, of successive jobs, or data characterizing the type of job(s). The actions may comprise actions that allocate particular jobs to particular computing resources; the reward(s) may be configured to minimize an overall queueing or processing time or the queueing or processing time for one or more individual jobs, or in general to optimize any metric based on the observations.

As another example the environment may comprise a real-world computer system or network, the observations may comprise any observations characterizing operation of the computer system or network, the actions performed by the software agent may comprise actions to control the operation e.g. to limit or correct abnormal or undesired operation e.g. because of the presence of a virus or other security breach, and the reward(s) may comprise any metric(s) that characterizing desired operation of the computer system or network.

In some applications, the environment is a real-world computing environment and the software agent manages distribution of tasks/jobs across computing resources e.g. on a mobile device and/or in a data center. In these implementations, the observations may comprise observations that relate to the operation of the computing resources in processing the tasks/jobs, the actions may include assigning tasks/jobs to particular computing resources, and the reward(s) may relate to one or more metrics of processing the tasks/jobs using the computing resources, e.g. metrics of usage of computational resources, bandwidth, or electrical power, or metrics of processing time, or numerical accuracy, or one or more metrics that relate to a desired load balancing between the computing resources.

In some applications the environment is a data packet communications network environment, and the agent is part of a router to route packets of data over the communications network. The actions may comprise data packet routing actions and the observations may comprise e.g. observations of a routing table which includes routing metrics such as a metric of routing path length, bandwidth, load, hop count, path cost, delay, maximum transmission unit (MTU), and reliability. The reward(s) may be defined in relation to one or more of the routing metrics i.e. configured to maximize one or more of the routing metrics.

In some other applications the environment is an Internet or mobile communications environment and the agent is a software agent which manages a personalized recommendation for a user. The observations may comprise previous actions taken by the user, e.g. features characterizing these; the actions may include actions recommending items such as content items to a user. The reward(s) may be configured to maximize one or more of: an estimated likelihood that the user will respond favorably to being recommended the (content) item, a suitability unsuitability of one or more recommended items, a cost of the recommended item(s), and a number of recommendations received by the user, optionally within a time span.

As a further example, the actions may include presenting advertisements, the observations may include advertisement impressions or a click-through count or rate, and the reward(s) may characterize previous selections of items or content taken by one or more users.

In some cases, the observations may include textual or spoken instructions provided to the agent by a third-party (e.g., an operator of the agent). For example, the agent may be an autonomous vehicle, and a user of the autonomous vehicle may provide textual or spoken instructions to the agent (e.g., to navigate to a particular location).

As another example the environment may be an electrical, mechanical or electro-mechanical design environment, e.g. an environment in which the design of an electrical, mechanical or electro-mechanical entity is simulated. The simulated environment may be a simulation of a real-world environment in which the entity is intended to work. The task may be to design the entity. The observations may comprise observations that characterize the entity, i.e. observations of a mechanical shape or of an electrical, mechanical, or electro-mechanical configuration of the entity, or observations of parameters or properties of the entity. The actions may comprise actions that modify the entity e.g. that modify one or more of the observations. The rewards or return may comprise one or more metric of performance of the design of the entity. For example rewards or return may relate to one or more physical characteristics of the entity such as weight or strength or to one or more electrical characteristics of the entity such as a measure of efficiency at performing a particular function for which the entity is designed. The design process may include outputting the design for manufacture, e.g. in the form of computer executable instructions for manufacturing the entity. The process may include making the entity according to the design. Thus the design of an entity may be optimized, e.g. by reinforcement learning, and then the optimized design output for manufacturing the entity, e.g. as computer executable instructions; an entity with the optimized design may then be manufactured.

As previously described the environment may be a simulated environment. Generally in the case of a simulated environment the observations may include simulated versions of one or more of the previously described observations or types of observations and the actions may include simulated versions of one or more of the previously described actions or types of actions. For example the simulated environment may be a motion simulation environment, e.g., a driving simulation or a flight simulation, and the agent may be a simulated vehicle navigating through the motion simulation. In these implementations, the actions may be control inputs to control the simulated user or simulated vehicle. Generally the agent may be implemented as one or more computers interacting with the simulated environment.

The simulated environment may be a simulation of a particular real-world environment and agent. For example, the system may be used to select actions in the simulated environment during training or evaluation of the system and, after training, or evaluation, or both, are complete, may be deployed for controlling a real-world agent in the particular real-world environment that was the subject of the simulation. This can avoid unnecessary wear and tear on and damage to the real-world environment or real-world agent and can allow the control neural network to be trained and evaluated on situations that occur rarely or are difficult or unsafe to re-create in the real-world environment. For example the system may be partly trained using a simulation of a mechanical agent in a simulation of a particular real-world environment, and afterwards deployed to control the real mechanical agent in the particular real-world environment. Thus in such cases the observations of the simulated environment relate to the real-world environment, and the selected actions in the simulated environment relate to actions to be performed by the mechanical agent in the real-world environment.

Optionally, in any of the above implementations, the observation at any given time step may include data from a previous time step that may be beneficial in characterizing the environment, e.g., the action performed at the previous time step, the reward received at the previous time step, or both.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions. Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are correspond toed in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes correspond toed in the accompanying figures do not necessarily require the particular order shown, or sequential order, to achieve desirable results. In some cases, multitasking and parallel processing may be advantageous.

What is claimed is:

1. A computer-implemented method of training an action selection system to generate action control data for controlling an agent to perform a learned task in an environment, comprising:
obtaining a set of skill action selection subsystems, each configured to process an observation characterizing a state of the environment in accordance with a respective skill action selection policy to generate a skill action selection output for selecting an action for the agent to perform a respective skill task;
collecting training data by, at each of a plurality of scheduler action time steps:
processing an observation of a current state of the environment using a scheduler neural network to generate a scheduler action that selects one of the skill action selection subsystems; and
for each of a set of action time steps:
processing an observation of the environment at the action time step using the selected skill action selection subsystem to select an action to be performed by the agent,
obtaining a subsequent observation characterizing a state of the environment after the agent performs the selected action, and a reward;
storing, in memory, training data comprising the observation, the selected action, the subsequent observation, and the reward;
the method further comprising:
keeping the skill action selection policies of the set of skill action selection subsystems unchanged whilst collecting the training data;
training the scheduler neural network on the observations and the rewards from the action time steps and on the scheduler actions, using reinforcement learning, to optimize a scheduler objective dependent on the rewards; and
training the action selection system on the stored training data, to generate action control data to control the agent to perform the learned task, using reinforcement learning.

2. The method of claim 1, further comprising using the trained action selection system to perform the learned task without the set of skill action selection subsystems and without the scheduler neural network.

3. The method of claim 1, comprising, for each of a plurality of training phases, collecting the training data in a first, exploration phase of the method during which actions selected by the set of skill action selection subsystems are used to explore the states of the environment, and training the action selection system on the stored training data in a second, training phase of the method.

4. The method of claim 1, further comprising, after training the action selection system, using the action selection system to control the agent to perform the learned task without using the scheduler neural network.

5. The method of claim 1, further comprising:
using the action selection system as one of the set of skill action selection subsystems whilst collecting the training data; and then
training the action selection system on the stored training data.

6. The method of claim 5, wherein the action selection system comprises an action selection neural network, the method further comprising:
maintaining parameters of the action selection neural network parameters unchanged whilst using the action selection neural network as one of the set of skill action selection subsystems during collection of the training data; and then
training the action selection neural network on the stored training data after collecting the training data using the action selection neural network.

7. The method of claim 1, wherein the scheduler action also selects a skill length that defines a number of time steps in the set of action time steps for which the selected skill action selection subsystem is used to select actions to be performed by the agent; the method further comprising:
processing the observation of a current state of the environment using the scheduler neural network to select the skill length; and
setting the number of time steps in the set of action time steps as the selected skill length.

8. The method of claim 7, further comprising:
storing, in the memory, training data comprising the scheduler action and a count that indexes each action time step of the set of action time steps; and
training the scheduler neural network on stored training data for each action time step comprising the observation for the time step, the reward for the time step, the scheduler action for the time step, the count for the time step, and the observation for the next time step.

9. The method of claim 8, wherein training the scheduler neural network further comprises:
augmenting the collected training data to generate additional scheduler actions by:
dividing the collected training data for a set of action time steps each having the same corresponding scheduler action, into a plurality of subsets of action time steps, each subset of action time steps having the same corresponding scheduler action, and defining a shortened skill length for each of the subsets of action time steps; and
modifying the count for each subset of time steps in the collected training data to count up to the shortened skill length defined by that subset of time steps.

10. The method of claim 8, further comprising:
training a Q value neural network that is configured to process the observation, the scheduler action, and the count, to generate a Q value; and
training the scheduler neural network using the Q-value neural network.

11. The method of claim 10, further comprising training the Q-value neural network using a target Q-value that, at an action time step corresponding to a scheduler time step, depends on a schedule action sampled using the scheduler neural network, and that depends on a current scheduler action otherwise.

12. The method of claim 1, wherein training the action selection system on the stored training data comprises training the action selection system using an offline reinforcement learning technique.

13. The method of claim 1, wherein the skill action selection subsystems comprise trained skill neural networks, each trained to process the observation characterizing the state of the environment, in accordance with respective skill neural network parameters, to generate the skill action selection output for selecting the action for the agent to perform the respective skill task; the method further comprising:
keeping the skill neural network parameters of each of the set of trained skill neural networks unchanged whilst collecting the training data.

14. The method of claim 1, wherein the observations relate to a real-world environment, and wherein the selected actions relate to actions to be performed by a mechanical agent, the method further comprising using the action selection system to control the mechanical agent to perform the learned task while interacting with a real-world environment by obtaining observations from one or more sensors sensing the real-world environment, processing the obtained observations using the action selection system to generate the action control data, and using the action control data to select actions to control the mechanical agent to perform the learned task.

15. (canceled)

16. The method of claim 1, wherein the environment is a real-world environment, wherein the agent is a mechanical agent, and wherein the action selection system is trained to select actions to be performed by the mechanical agent in response to observations obtained from one or more sensors sensing the real-world environment, to control the agent.

17. One or more computer storage media storing instructions that when executed by one or more computers cause the one or more computers to perform operations for training an action selection system to generate action control data for controlling an agent to perform a learned task in an environment, the operations comprising:
obtaining a set of skill action selection subsystems, each configured to process an observation characterizing a state of the environment in accordance with a respective skill action selection policy to generate a skill action selection output for selecting an action for the agent to perform a respective skill task;
collecting training data by, at each of a plurality of scheduler action time steps:
processing an observation of a current state of the environment using a scheduler neural network to generate a scheduler action that selects one of the skill action selection subsystems; and
for each of a set of action time steps:
processing an observation of the environment at the action time step using the selected skill action selection subsystem to select an action to be performed by the agent,
obtaining a subsequent observation characterizing a state of the environment after the agent performs the selected action, and a reward;
storing, in memory, training data comprising the observation, the selected action, the subsequent observation, and the reward;
the method further comprising:
keeping the skill action selection policies of the set of skill action selection subsystems unchanged whilst collecting the training data;
training the scheduler neural network on the observations and the rewards from the action time steps and on the scheduler actions, using reinforcement learning, to optimize a scheduler objective dependent on the rewards; and
training the action selection system on the stored training data, to generate action control data to control the agent to perform the learned task, using reinforcement learning.

18. A system comprising:
one or more computers; and
one or more storage devices communicatively coupled to the one or more computers, wherein the one or more storage devices store instructions that, when executed by the one or more computers, cause the one or more computers to perform operations for training an action selection system to generate action control data for controlling an agent to perform a learned task in an environment, the operations comprising:
obtaining a set of skill action selection subsystems, each configured to process an observation characterizing a state of the environment in accordance with a respective skill action selection policy to generate a skill action selection output for selecting an action for the agent to perform a respective skill task;
collecting training data by, at each of a plurality of scheduler action time steps:
processing an observation of a current state of the environment using a scheduler neural network to generate a scheduler action that selects one of the skill action selection subsystems; and
for each of a set of action time steps:
processing an observation of the environment at the action time step using the selected skill action selection subsystem to select an action to be performed by the agent,
obtaining a subsequent observation characterizing a state of the environment after the agent performs the selected action, and a reward;
storing, in memory, training data comprising the observation, the selected action, the subsequent observation, and the reward;
the method further comprising:
keeping the skill action selection policies of the set of skill action selection subsystems unchanged whilst collecting the training data;
training the scheduler neural network on the observations and the rewards from the action time steps and on the scheduler actions, using reinforcement learning, to optimize a scheduler objective dependent on the rewards; and
training the action selection system on the stored training data, to generate action control data to control the agent to perform the learned task, using reinforcement learning.

19. The system of claim 18, wherein the operations further comprise using the trained action selection system to perform the learned task without the set of skill action selection subsystems and without the scheduler neural network.

20. The system of claim 18, wherein the operations further comprise, for each of a plurality of training phases, collecting the training data in a first, exploration phase of the method during which actions selected by the set of skill action selection subsystems are used to explore the states of the environment, and training the action selection system on the stored training data in a second, training phase of the method.

21. The system of claim 18, wherein the operations further comprise, after training the action selection system, using the action selection system to control the agent to perform the learned task without using the scheduler neural network.
